(19) United States
(12) Patent Application Publication
(10) Pub. No.: US 2005/0166407 A1
(43) Pub. Date: Aug. 4, 2005

(54) Portable toe alignment device

(76) Inventor: Edward Alton Lumpkin JR., Batesville, AR (US)

Correspondence Address: Eddie Lumpkin, 11 Lumpkin Drive, Batesville, AR, 72501, US

(21) Appl. No.: 10/770,554

(22) Filed: Feb. 3, 2004

(51) Int. Cl. G01B 5/24

(52) U.S. Cl. 33/203.14

(57) ABSTRACT

A portable, light weight device for determining the toe in alignment of a wheel on a motor vehicle in which a base plate functions in cooperation with a slide which has limited transverse movement relative to said base plate, the movement being generated by the position of the slide relative to the toe in of a tire as it moves across the alignment device.

### BACKGROUND OF THE INVENTION

1. Field of the Invention

The “toe alignment” of the front or rear wheels of a vehicle is defined as the angular relationship of the principal plane of the front or rear wheels to the vertical plane passing through the longitudinal axis of the vehicle.

It is imperative, from a safety standpoint that the “toe in alignment” be within tolerance to assure driving stability, increased tire life and reduced fuel consumption because of reduced friction. Nonetheless, it is a common occurrence that one runs over a pot hole or hits a curb, the consequence being a potential misalignment, including toe in.

It is acknowledged that it is impractical for most vehicle owners to own or operate an expensive alignment device. Indeed, such devices are found almost exclusively in professional shops. It is still essential to keep a check on “toe” since this is the most common failure of alignment. The question becomes one of how does the average, non professional, determine, at minimal cost, that his or her vehicle is out of alignment.

Overview of the Applicable Art

There has been found no device which is affordable and useable by an average, non professional driver to determine the existence of an alignment problem. There are, of course, devices such as that depicted in Bennett U.S. Pat. No. 1,675,481, in which a plurality of balls 15 separate upper and lower runner boards. A vehicle is driven on to the upper board where the alignment of each wheel is measured in turn. The Bennett device is clearly a professional device and far to sophisticated and expensive to be found in one's garage at home.

There are several such, obviously professional, devices which inhabit professional shops, but there is no known device available to the average motorist, at least until the advent of the present invention.

### SUMMARY OF THE INVENTION

The present invention relates, in a general sense, to a home testing device for determining the toe in of each wheel of a motor vehicle.

It is an objective of the present invention to provide a motorist, consumer with such a device which technically understandable, and readily useable by a motorist with minimal to no experience in such testing devices.

It is another objective, related to the foregoing, to provide a light weight, easily maintained, home testing device of the type described which is sufficiently inexpensive as to make it readily available to the average motorist, even one of modest resources.

In summary, the overall object of this invention is to give a portable, durable, inexpensive, convenient and simple means by which the operator of a vehicle can check the “toe in” of a vehicle at their convenience, and at home.

In the scheme of things, probably the single most important object of this invention is its simplicity of use, which can be understood by anyone who operates a vehicle.

### BRIEF DESCRIPTION OF THE DRAWINGS

FIG. 1, is an exploded view, in perspective, of a portable toe in testing device constructed in accordance with the present invention;

FIG. 2, is a perspective view of the device of FIG. 1, shown assembled and ready for use; and

FIG. 3, is a partial sectional view of the device of FIG. 2, taken along lines A-A;

FIG. 4 is an exploded view, in perspective, of a slightly modified embodiment of the present invention;

FIG. 5 is an assembled perspective view of the modified form of the invention as shown in FIG. 4; and,

FIG. 6 is a partial sectional view taken along lines B-B of FIG. 5, illustrating the interrelationship between the slide and the end plates thereof.

### DETAILED DESCRIPTION OF THE PREFERRED EMBODIMENT

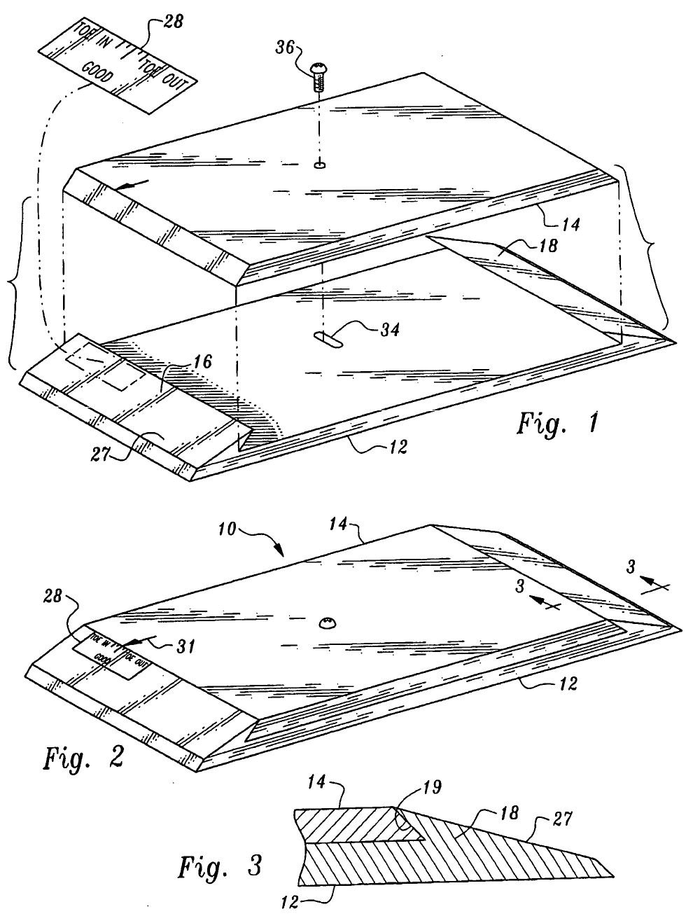

With reference now to the drawings, and initially to FIG. 1, a portable toe in testing device is illustrated at 10.

The testing device 10, in its most simple form, comprises a base plate 12. A slide, in the nature of the plate 14 is provided and is adapted to overlay the base plate 12. The surfaces of both plates are coated, or otherwise made of a low friction material, e.g., Teflon® or nylon®, although any material that meets the essential low friction criteria is within the contemplation of the invention.

The base plate 12 is formed or affixed with end plates 16 and 18 respectively. The end plates are notched at 19 so as to partially overlay the free surface 21 of the base plate, and when the slide is inserted the notches restrict its movement to a transverse direction, inhibiting movement along its longitudinal axis.

In order that a surface of the slide 14 can rest on the surface 21 with its motion relative thereto limited to transverse movement only, the ends 23 and 25 respectively of the slide are beveled, thus permitting the slide to be slipped under the end plates 16 and 18, within the notches 19 with sufficient clearance to permit the slide 14 to move in a direction transverse to the longitudinal axis of the testing device, while inhibiting movement along that axis. The end plates serve as ramps as at 27 in order that a wheel can be readily driven over the device.

A gauge 28 is mounted in the end piece 16, where it senses movement of the slide as the vehicle is moved longitudinally, first across end piece 16 and continuing its movement across end piece 18 and away from the device. The needle 31 of the gauge 28 will set at its position of maximum deflection, thereby indicating the toe in of the wheel which has just moved across the testing device 10.

A transverse slot 34 is centrally disposed in the base plate and a fastener 36 is inserted through the slide and is secured in the slot 34 with sufficient, but limited, play as to permit the ready transverse movement of the slide relative to the base while holding the two together. It has been found that limited movement of about one-half inch is sufficient.

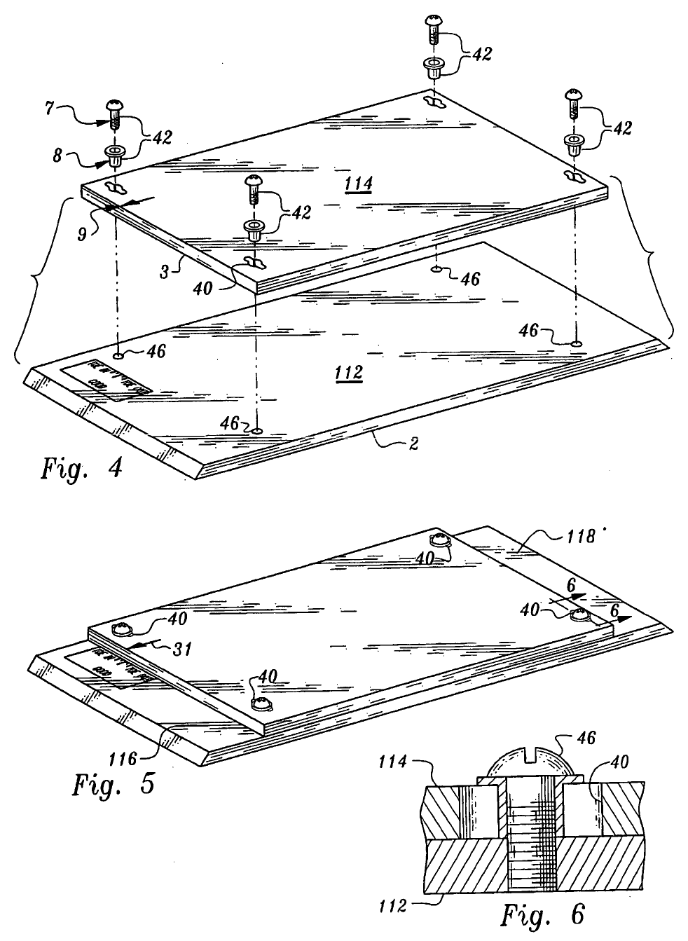

FIGS. 4 through 6 illustrate a slightly modified relationship between the base plate 12 and slider 14. In this modified form, the end plates 16 and 18 are not notched as they were in the FIG. 1 embodiment at 19, but simply squared off.

In the FIG. 4 embodiment, the slider is fashioned with at least four slots 40. It will be seen that the orientation of the slots is transverse to the longitudinal axis of the portable toe in alignment device, each of the slots 40 being aligned in the same direction, i.e., transverse to the longitudinal axis of the device. The slots are uniformly spaced near the far corners of the plate, although the specific orientation may vary.

Fasteners 42 are fitted with shims 44 and are fitted through the slots and into the base plate wherein fastener receptacles 46 are fitted.

In the operation of each embodiment, the slide will move to the left or right and hold its adjusted position as the vehicle drives over the alignment device. The FIG. 4 embodiment provides for slightly less friction with the end plates 16 and 18 than would be existing in the FIG. 1 embodiment, although both devices will provide the user with a reading of the alignment of each wheel that is driven over the device.

FIGS. 1 and 4 graphically illustrate the simplicity of using the alignment device. Initially, the operator of a vehicle simply drives straight and slowing across the device, then stops the car and picks up the light weight device 10 to read the results. If the gage 28 remains on center, it can be construed that the “toe in” of the car is according to specification. If the needle 31 of the gauge 28 has moved, the “toe in” is is either in or out, as the needle so indicates.

It will be appreciated that the precise number of fasteners in either the FIG. 1 or FIG. 4 devices may vary without departure from the invention.

While I have described successful structures for constructing my invention, it is possible in the art to make various modifications and still achieve the results desired, without departure from the invention as outlined in the claims below.

1-3. (canceled)

4. A portable toe in alignment device comprising a base plate;
a slide, said base plate and said slide having opposed anti-friction surfaces;
said surfaces being in sliding engagement with one another;
base plates; said base plates being disposed at both ends of said base plate; said end plates having sloping sides serving as ramps; each of said end plates being notched immediately above said surfaces of said base plate so as to receive said slide within said notch restricting its movement on said base plate to motion transverse to the longitudinal axis of said toe in alignment device.

5. The portable toe in alignment device of claim 4, wherein one of said end plates is provided with a gauge, said gauge measuring the transverse deflection of said slide on said base plate when a vehicle is driven over said toe in alignment device.

6. The portable toe in alignment device of claim 4, wherein said slide and said base plate are secured by a fastener, said fastener extending between said slide and said base plate to further limit movement of said slide relative to said base plate, except in an axis transverse to the longitudinal axis of said alignment device.

7. The portable toe in alignment device of claim 4, having a transverse slot in said base plate; an aperture in said slide for receipt of a fastener; a fastener loosely connecting said slide and said base plate so as to permit limited transverse movement of said slide relative to said base plate.

8. The portable toe in alignment device of claim 4, wherein a series of fasteners are provided, said fasteners interconnecting said base plate and said slide to limit said slide to movement transverse to said longitudinal axis of said alignment device.

9. The portable toe in alignment device of claim 8, wherein said fasteners are equally positioned near the four corners of said slide.
